(19) United States
(12) Patent Application Publication
(10) Pub. No.: US 2009/0162728 A1
(43) Pub. Date: Jun. 25, 2009

(54) Fuel Cell

(75) Inventors: Toshiyuki Inagaki, Aichi (JP); Akihiko Takami, Aichi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi-ken (JP)

(21) Appl. No.: 12/086,061

(22) PCT Filed: Jun. 15, 2007
(86) PCT No.: PCT/JP2007/062550

§ 371 Date: Jun. 5, 2008

(30) Foreign Application Priority Data
Jun. 20, 2006 (JP) 2006-170518

(51) Int. Cl. H01M 2/00

(52) U.S. Cl. 429/34

(57) ABSTRACT

A fuel cell of the present invention includes: a cell laminated body having a plurality of cells laminated; an end plate provided outside the cell laminated body in a laminating direction of the cell laminated body; and a load adjusting screw provided in the end plate for adjusting a compression load applied to the cell laminated body by moving in the laminating direction of the cell laminated body. A stopper in which an internal thread to be engaged with the load adjusting screw is formed so as to protrude toward the cell laminated body is provided on the end plate such that the rotation thereof with respect to an end plate body of the end plate in the axis direction is regulated.

### TECHNICAL FIELD

The present invention relates to a fuel cell having a load adjusting screw that adjusts a compression load applied to a cell laminated body formed by laminating power generating cells.

### BACKGROUND ART

In recent years, for example, fuel cell vehicles having as an energy source a fuel cell that generates electricity using an electrochemical reaction between a fuel gas and an oxidizing gas have drawn attention.

In general, the fuel cell is formed of a fuel cell stack including: a cell laminated body formed by laminating a predetermined number of cells that generate electricity using an electrochemical reaction between a fuel gas and an oxidizing gas; and end plates that are provided outside the cell laminated body in a laminating direction of the cell laminated body, and applies a compression load adjusted by a load adjusting screw to the cell laminated body.

In addition, as this type of fuel cell, the following structure has been proposed: a plate member having an internal thread formed therein is fitted to a hole formed in an end plate; the screwed amount of the load adjusting screw engaged with the internal thread formed in the plate member is controlled to adjust the pressing force of a pressure member provided on the cell laminated body to the cell laminated body (for example, see Japanese Patent Application Publication JP H08-171926A).

### DISCLOSURE OF THE INVENTION

Meanwhile, the thickness of the cell laminated body forming the fuel cell stack depends on the thickness of the cell or the number of cells. Therefore, it is necessary to prepare plural kinds of load adjusting screws having different lengths that correspond to the thickness of the cell laminated body so that the load adjusting screw can engage with threads of the internal thread formed in the end plate or the plate member that is fitted to the hole of the end plate.

Further, since the number of threads depends on the thickness of the end plate or the plate member, it is also necessary to prepare plural kinds of load adjusting screws having different lengths so that the load adjusting screw can engage with the threads of the internal thread.

Accordingly, an object of the present invention is to provide a fuel cell capable of applying a load to a cell laminated body according to the length of a cell laminated body or the thickness of an end plate etc., without preparing load adjusting screws having different lengths.

In order to achieve the object, a fuel cell according to an aspect of the present invention includes: a cell laminated body having a plurality of cells laminated; an end plate provided outside the cell laminated body in a laminating direction of the cell laminated body; and a load adjusting screw provided in the end plate for adjusting a compression load applied to the cell laminated body by moving in the laminating direction of the cell laminated body, wherein an internal thread member in which an internal thread to be engaged with the load adjusting screw is formed so as to protrude toward the cell laminated body is provided on the end plate such that the rotation thereof with respect to the end plate in an axis direction is regulated.

According to the above-mentioned structure, it is possible to sufficiently ensure the range of threads that can be engaged with the load adjusting screw. As a result, it is possible to apply a compression load to the cell laminated body using a load adjusting screw having a predetermined length, without preparing various kinds of load adjusting screws having different lengths according to the thickness of the end plate etc. or the thickness of the cell laminated body that depends on the thickness of the cell or the number of cells laminated.

In the fuel cell according to the above-mentioned aspect, preferably, the internal thread member includes: a boss portion having the internal thread formed therein and passing through the end plate; and a flange portion extending from an intermediate position of the boss portion in the axis direction to the outside in a radial direction and coming into contact with the end plate. The flange portion may have such a tapered shape that the thickness thereof becomes smaller as it becomes more distant from the boss portion.

According to the fuel cell of the above-mentioned aspect, it is possible to apply a load to the cell laminated body, without preparing various kinds of load adjusting screws having different lengths according to the thickness of the end plate etc. or the thickness of the cell laminated body.

### BRIEF DESCRIPTION OF THE DRAWINGS

FIG. 1 is a front cross-sectional view illustrating a fuel cell according to an embodiment of the present invention.

FIG. 2 is a front cross-sectional view illustrating a fuel cell according to another embodiment of the present invention.

### BEST MODE FOR CARRYING OUT THE INVENTION

Hereinafter, embodiments of a fuel cell according to the invention will be described with reference to the accompanying drawings.

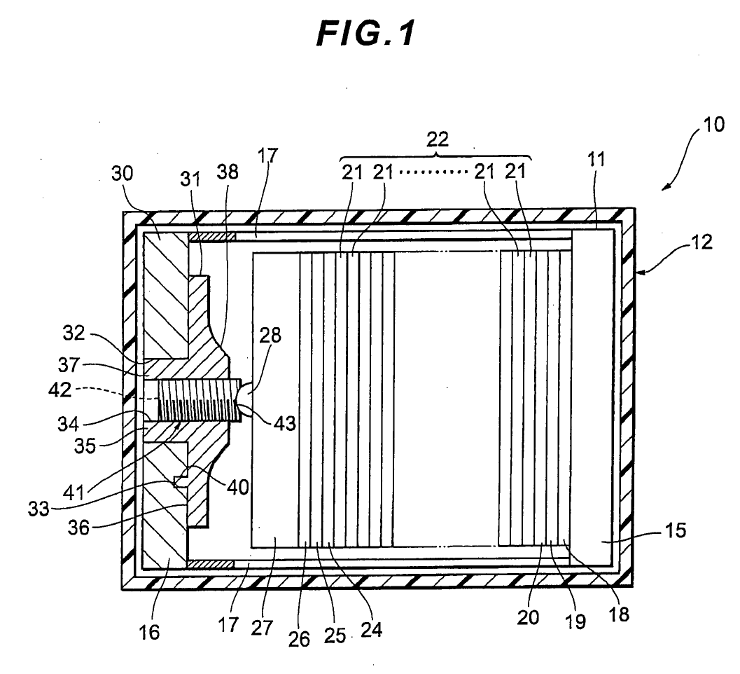

FIG. 1 is a diagram illustrating a fuel cell 10. The fuel cell 10 can be applied to an in-vehicle power generating system of a fuel cell vehicle, a mobile power generating system used for, for example, a ship, an airplane, a trolley car, or a walking robot, and a stationary power generating system for a structure (for example, a house and a building). Specifically, the fuel cell 10 is used for a vehicle.

The fuel cell 10 includes a fuel cell stack 11 and a stack case 12 that is formed of an insulating material, such as a synthetic resin, and covers the outside of the fuel cell stack 11. In addition, the stack case 12 may be formed of a metal film coated with an insulating material such as a synthetic resin.

The outside of the fuel cell stack 11 is formed by connecting the edges of a pair of rectangular end plates 15 and 16 with a tension plate 17, and the end plates 15 and 16 and the tension plate 17 are formed of, for example, duralumin.

Further, in the fuel cell stack 11, a rectangular insulating plate 18, a terminal plate 19, and a cover plate 20 are disposed on one side of the end plate 15 facing the end plate 16 in this order from the one side of the end plate 15. A cell laminated body 22 formed by laminating a predetermined number of cells 21 is provided on one side of the cover plate 20 facing the end plate 16.

The cells 21 have rectangular shapes in plan view, and are laminated in a direction linking the end plates 15 and 16. The cells 21 are supplied with a fuel gas and an oxidizing gas and generate electricity.

Furthermore, in the fuel cell stack 11, a rectangular cover plate 24, a terminal plate 25, and an insulating plate 26 are disposed on one side of the cell laminated body 22 facing the end plate 16 in this order from the cell laminated body 22. A spring box 27 having a rectangular shape in plan view is arranged on one side of the insulating plate 26 facing the end plate 16.

The spring box 27 has a plurality of coil springs (not shown) provided therein. These coil springs urge the insulating plate 26, that is, the cell laminated body 22 in the laminating direction. In addition, a hemispherical protrusion 28 is formed at the center of the spring box 27 so as to protrude in the opposite direction of the cell laminated body 22.

In this embodiment, the end plate 16 includes a rectangular end plate body 30 that is connected to the tension plate 17 and a stopper (an internal thread member) 31 that is provided within the position where the end plate body 30 is connected to the tension plate 17.

A through hole 32 is formed at the center of the end plate body 30 in the thickness direction of the end plate body 30.

In addition, a rotation regulating hole 33 is formed in one surface of the end plate body 30 facing the cell laminated body 22 so as to be parallel to the through hole 32. The rotation regulating hole 33 has a circular shape, as viewed from an axis direction.

The stopper 31 comes into contact with one surface of the end plate body 30 facing the spring box 27, and reinforces the end plate 16 including the end plate body 30. The stopper 31 includes a cylindrical boss portion 35 having an internal thread 34 formed-therein and a flange portion 36 with a predetermined thickness. The flange portion 36 is coaxially formed with the boss portion 35, and has a substantially discoid shape that extends from a substantially central position of the boss portion 35 in the axis direction thereof to the outside in the radial direction.

The stopper 31 includes a cylindrical portion 37 that protrudes from one surface of the flange portion 36 in the axis direction of the boss portion 35, and the cylindrical portion 37 is inserted into the through hole 32 of the end plate body 30, so that the entire surface of the flange portion 36 comes into contact with the end plate body 30. In this case, the length of the cylindrical portion 37 of the stopper 31 in the axis direction is equal to the length of the through hole 32 of the end plate body 30 in the axis direction, and an end surface of the cylindrical portion 37 is flush with the outer surface of the end plate body 30.

The stopper 31 further includes a cylindrical portion 38 that protrudes toward the cell laminated body 22. The flange portion 36 is slightly tapered such that the thickness of the flange portion 36 becomes smaller as it becomes more distant from the cylindrical portion 38. In addition, in order to reinforce the flange portion 36, a rib may be radially formed from the cylindrical portion 38.

The stopper 31 further includes a cylindrical rotation regulating pin 40 that protrudes from the flange portion 36 in the cylindrical portion 37 side in the axis direction so as to be parallel to the cylindrical portion 37. The distance between the center of the boss portion 35 and the center of the rotation regulating pin 40 is equal to the distance between the center of the through hole 32 and the center of the rotation regulating hole 33 in the end plate body 30.

The cylindrical portion 37 of the boss portion 35 is inserted into the through hole 32, and the rotation regulating pin 40 is inserted to the rotation regulating hole 33. In this way, the stopper 31 is set to the end plate body 30 with rotation of the stopper 31 with respect to the end plate body 30 being regulated.

The end plate 16 includes a load adjusting screw 41 that is engaged with the internal thread 34 of the stopper 31, and the load adjusting screw 41 comes into contact with the protrusion 28 of the spring box 27. A concave portion 43 is formed in one surface of the load adjusting screw 41 facing the protrusion 28, and the protrusion 28 is fitted to the concave portion 43.

In addition, a tool fitted portion 42 to which a tool such as a hexagonal bolt is fitted is formed on the surface of the load adjusting screw 41 opposite to the protrusion 28, and the load adjusting screw 41 is rotated by the tool fitted to the tool fitted portion 42 and moves in the axis direction to adjust a load applied to the cell laminated body 22.

When the load adjusting screw 41 is rotated, the stopper 31 also comes close to rotating. However, since the rotation regulating pin 40 is in contact with the inside wall surface of the rotation regulating hole 33 of the end plate body 30, the rotation of the stopper 31 with respect to the end plate body 30 is regulated. When a large amount of load is applied to the spring box 27, the rotation is also regulated by friction between the end plate body 30 and the flange portion 36. As a result, only the load adjusting screw 41 is rotated with respect to the end plate body 30.

As described above, in the fuel cell according to this embodiment, the stopper 31, which includes the internal thread 34 that can be engaged with the load adjusting screw 41 and protrudes toward the cell laminated body 22, is provided on the end plate 16. Therefore, it is possible to sufficiently ensure the range of threads that can be engaged with the load adjusting screw 41.

In this way, it is possible to press the spring box 27 using the load adjusting screw 41 having a predetermined length to apply a compression load to the cell laminated body 22, without preparing various types of load adjusting screws 41 having different lengths according to the thickness of the cell laminated body 22 that varies according to the thickness of the cell 21 or the number of cells laminated, or the thickness of the end plate 16 etc. Particularly, this structure is effective when the thickness of the end plate 16 is small, and so it is difficult to form an internal thread.

In addition, since the rotation of the stopper 31 with respect to the end plate 16 is regulated, it is possible to effectively move the load adjusting screw 41 in the axis direction without rotating the stopper 31 together with the load adjusting screw 41.

Since the stopper 31 is fitted to the end plate 16 side, the twist due to the rotation of the load adjusting screw 41 can be transmitted to the end plate 16 side and then absorbed by the tension plate 17, and so it is possible to decrease the action of the twist on the cell laminated body 22. Thus, it is possible to prevent the influence of the twist on the cell laminated body 22.

Further, the cylindrical portion 38 of the stopper 31 protrudes toward the cell laminated body 22, and the flange portion 36 is slightly tapered such that the thickness of the flange portion 36 becomes smaller as it becomes more distant from the cylindrical portion 38. Therefore, for example, even when the spring box 27 pressed by the load adjusting screw 41 is inclined, it is possible to prevent the interference between the stopper 31 and the spring box 27.

Furthermore, a rotation regulating pin may be formed on the end plate body 30, and a rotation regulating hole to which the rotation regulating pin is inserted may be formed in the flange portion 36 of the stopper 31.

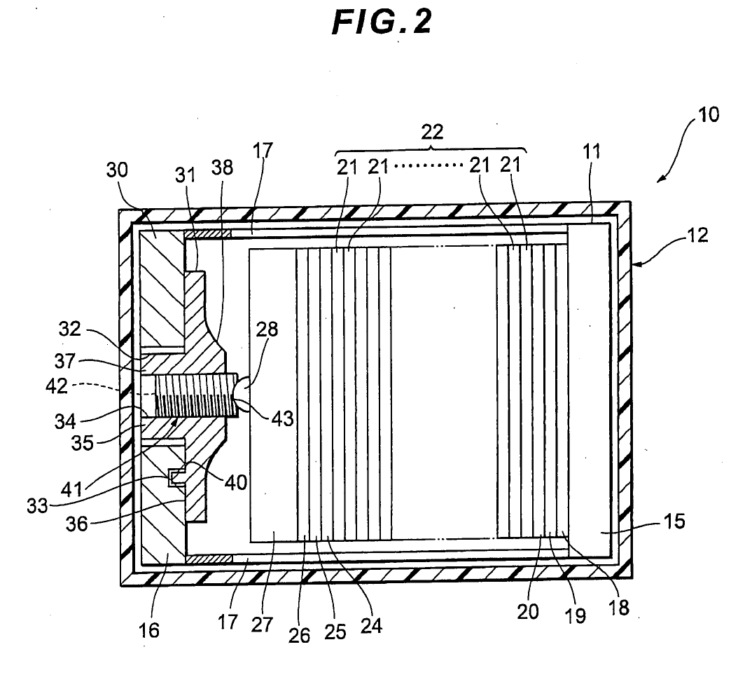

FIG. 2 is a diagram illustrating another embodiment of the present invention. As shown in FIG. 2, in this embodiment, the diameter of the through hole 32 is larger than the diameter of the cylindrical portion 38, and the diameter of the rotation regulating hole 33 is larger than the diameter of the rotation regulating pin 40. In this way, the stopper 31 has play with respect to the end plate body 30 wherein the stopper 31 can move in the diametric direction of the internal thread 34, that is, in the diametric direction of the load adjusting screw 41 engaged with the internal thread 34, and the stopper 31 can move 360 degrees in the diametric direction. As a result, the load adjusting screw 41 engaged with the internal thread 34 can also move with respect to the end plate 16 in the diametric direction, and the load adjusting screw 41 can move 360 degrees in the diametric direction.

According to the above-mentioned structure, the load adjusting screw 41 can move with respect to the end plate 16 in the diametric direction. As a result, the concave portion 43 of the load adjusting screw 41 and the protrusion 28 of the spring box 27 that are engaged so as to be aligned with each other in the diametric direction of the load adjusting screw 41 can move with respect to the end plate 16 in the diametric direction of the load adjusting screw 41. Therefore, the end plate 16 and the spring box 27 can be aligned with each other in the diametric direction of the load adjusting screw 41, that is, in a direction orthogonal to the laminating direction of the cell laminated body 22, which makes it possible to improve assembly accuracy.

Further, a spot facing hole having a larger diameter than that of the flange portion 36 of the stopper 31 may be formed in the end plate body 30, and the flange portion 36 of the stopper 31 may be inserted into the spot facing hole.

1. A fuel cell comprising: a cell laminated body having a plurality of cells laminated; an end plate provided outside the cell laminated body in a laminating direction of the cell laminated body; and a load adjusting screw provided in the end plate for adjusting a compression load applied to the cell laminated body by moving in the laminating direction of the cell laminated body,
wherein an internal thread member in which an internal thread to be engaged with the load adjusting screw is formed so as to protrude toward the cell laminated body is provided on the end plate such that the rotation thereof with respect to the end plate in an axis direction is regulated.

2. The fuel cell according to claim 1,
wherein the internal thread member includes: a boss portion having the internal thread formed therein and passing through the end plate; and a flange portion extending from an intermediate position of the boss portion in the axis direction to the outside in a radial direction and coming into contact with the end plate,
wherein the flange portion has such a tapered shape that the thickness thereof becomes smaller as it becomes more distant from the boss portion.

3. The fuel cell according to claim 2, wherein:
a pin protruding from the surface of the flange portion coming into contact with the end plate is formed on the surface; and
a hole to be inserted by the pin is formed in the surface of the end plate coming into contact with the flange portion.

4. The fuel cell according to claim 3, wherein:
the diameter of the portion through which the boss portion passes is larger than that of the boss portion;
the diameter of the hole is larger than that of the pin; and thereby,
the internal thread member has play in the diametric direction of the internal thread with respect to the end plate.
